(19) United States
(12) Patent Application Publication
(10) Pub. No.: US 2025/0006985 A1
(43) Pub. Date: Jan. 2, 2025

(54) SILICON NITRIDE STABILIZED INTERFACE BETWEEN LITHIUM METAL AND SOLID ELECTROLYTE FOR HIGH PERFORMANCE LITHIUM METAL BATTERIES

(71) Applicants: Quinn Qiao; Abiral Baniya

(72) Inventors: Quinn Qiao; Abiral Baniya

(73) Assignee: Syracuse University, Syracuse, NY (US)

(21) Appl. No.: 18/710,439

(22) PCT Filed: Nov. 15, 2022
(86) PCT No.: PCT/US22/49895

§ 371 Date: May 15, 2024

Related U.S. Application Data
(60) Provisional application No. 63/279,336, filed on Nov. 15, 2021.

(51) Int. Cl. H01M 10/0562; H01M 4/02; H01M 4/40; H01M 10/052

(52) U.S. Cl. CPC H01M 10/0562; H01M 4/405; H01M 10/052; H01M 2004/027; H01M 2004/028; H01M 2300/0077

(57) ABSTRACT

A solid-state lithium battery having an interfacial layer of silicon nitride (Si₃N₄) that ensures an intimate contact between a garnet-type electrolyte and the lithium due to its lithiophilic nature and formation of an intermediate lithium-metal alloy. The interfacial resistance experiences an exponential drop from 1197 Ωcm² to 84.5 Ωcm² and lithium symmetrical cells with an Si₃N₄-modified garnet exhibited low overpotential and long-term stable plating/stripping cycles at room temperature compared to bare garnet and was demonstrated to operate with high cycling efficiency and energy density, excellent rate capability and stability.

### BACKGROUND OF THE INVENTION

### 1. Field of the Invention

The present invention relates to solid-state lithium batteries and, more particularly, to an approach for improving the interface between a garnet-type electrolyte and the lithium metal.

### 2. Description of the Related Art

High energy and safe battery technologies hold the key to the future of energy markets in both transportation and portable electronics. Currently, Lithium-Ion Batteries (LIBs) are used worldwide as the workhorse powering these applications. Commercial LIBs are based on the dual-intercalation chemistries in graphitic anode and lithium metal oxides (LiCoO₂, NMC, NCA) cathode enabled by ion transport across the liquid electrolytes. The ceiling of energy density allowed by such intercalation chemistries approaches 300 Wh/kg, while any attempt to push the energy density higher must face the risks imposed by highly flammable organic electrolyte solvents. Replacing graphite with lithium metal (Li°) as anode presents an ultimate solution, since lithium combines high specific capacity (3860 mAhg⁻¹) with the lowest reduction potential (−3.04 V vs Li/Li⁺) among all elements in the Periodic Table. However, such low potential also makes lithium extremely reactive in contact with almost any electrolyte component, the consequence of which is the formation of dendritic and dead lithium, two dangerous morphologies often held responsible for fire and other safety hazards. Liquid electrolytes also impose limitations on performance of high voltage cathodes, due to their lower anodic stability. Therefore, development of high energy and safe battery technologies relies on the replacement of liquid electrolytes with a fast ion conductor that does not combust.

Solid-state batteries (SSBs) employing solid-state electrolytes (SSEs) hold such promises for the next-generation energy storage devices as long as they could be stable in presence of both lithium and high-voltage cathode while conducting ions at fast rate. For example, solid-state lithium batteries are generally considered as the next-generation battery technology that benefits from inherent nonflammable solid electrolytes and safe harnessing of high-capacity Li°. Several solid electrolyte systems have been thoroughly explored, which ranges from sulfides to oxides and oxynitrides such as perovskite, antiperovskite, LISICON, thio-LISICON, NASICON, garnet, sulfide glass ceramic, etc. Certain sulfide SSEs (e.g., LGPS) are known for their ionic conductivity above 1 mScm⁻¹ at room temperature, but their sulfide-nature renders them to be thermodynamically unstable against Li° or high voltage cathodes, while other emerging electrolytes such as LIPON and LATP also tends to react with Li° anode (e.g., Ti⁴⁺/Ti³⁺ redox reaction). Among various solid electrolyte candidates, cubic garnet-type Li₇La₃Zr₂O₁₂ (LLZO) ceramics hold superiority due to their high ionic conductivity (10⁻³ to 10⁻⁴ S/cm) and good chemical stability against Li°. Only garnet SSEs, represented by Li₇La₃Zr₂O₁₂ (LLZO), provides both high ionic conductivity close to 1 mScm⁻¹ at room temperature, wide electrochemical window and good electrochemical stability against Li° anode.

Practical deployment of solid-state batteries based on such garnet-type materials has been constrained by poor interfacing between lithium and garnet that displays high impedance and uneven current distribution. For example, a major hurdle for garnets still prevail: its poor contact with Li° which arises from the microscopic gaps that exists at solid-solid interfaces, and always leads to high interfacial impedance and poor cycling performance. Diversified strategies such as altering the chemical composition of the electrolyte, applying external heat and pressure, electrolyte surface modification and interface modification have been adopted, among which the introduction of a buffer layer between garnet SSEs and Li° has been proven efficient and promising. Buffer layers in the form of metals (such as Al, Si, Ge, Mg), metal oxides (such as Al₂O₃, ZnO) and carbon material (such as graphite) have significantly reduced impedance and improved cell performances. Computational analysis has revealed that material stability against Li° depends on their cation and anion chemistry. Upon contact with Li° these oxides, sulfides, and fluorides usually become unstable which leads to the formation of an interlayer that is similar to interphase formed between Li° and liquid electrolytes. Since such formation process consumes active materials, while the interlayer itself serves as a physical barrier to ion transport, an ideal interlayer chemistry should minimize footprint in both effects, hence metal nitrides is preferred as it is more stable against Li° than oxides, sulfides and fluorides. Accordingly, there is a need in the art for an approach that can provide a stable interface between the electrolyte and the Li° to improve overall cycling and rate performance.

### BRIEF SUMMARY OF THE INVENTION

The present invention is a facile and effective strategy to significantly reduce the interfacial mismatch in solid-state lithium batteries employing a garnet-type electrolyte by modifying the surface of the garnet-type solid electrolyte with a thin layer of silicon nitride (Si₃N₄). This interfacial layer ensures an intimate contact with lithium due to its lithiophilic nature and formation of an intermediate lithium-metal alloy. The interfacial resistance experiences an exponential drop from 1197 Ωcm² to 84.5 Ωcm². Lithium symmetrical cells with Si₃N₄-modified garnet exhibited low overpotential and long-term stable plating/stripping cycles at room temperature compared to bare garnet. Furthermore, a hybrid solid-state battery with Si₃N₄-modified garnet sandwiched between Li° anode and LiFePO₄ (LFP) cathode was demonstrated to operate with high cycling efficiency and energy density, excellent rate capability and stability. The nitride interface of the present invention, denoted as Si₃N₄@Al-LLZO, showed stable interface during cycling of symmetrical cells for prolonged period of more than 800 hours. With optimization of the Si₃N₄@Al-LLZO interfacial layer, Li/Si₃N₄@Al-LLZO/LFP full cells showed excellent overall cycling and rate performance. The present invention thus represents a significant advancement towards use of garnet solid electrolytes in Li° batteries for the next generation energy storage devices.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a characterization as-prepared Al-LLZO garnet electrolyte pellet with showing a XRD comparison of Al-LLZO garnet pellet that matches with cubic structure Li₅La₃Nb₂O₁₂,

FIG. 2 is a pair of SEM images showing surface and cross-section of Al-LLZO pellets.

FIG. 3 is a graph of the EIS spectra of Al-LLZO electrolyte at elevated temperatures ranging from 22-60° C.

FIG. 4 is a graph showing an Arrhenius plot of Al-LLZO ionic conductivity;

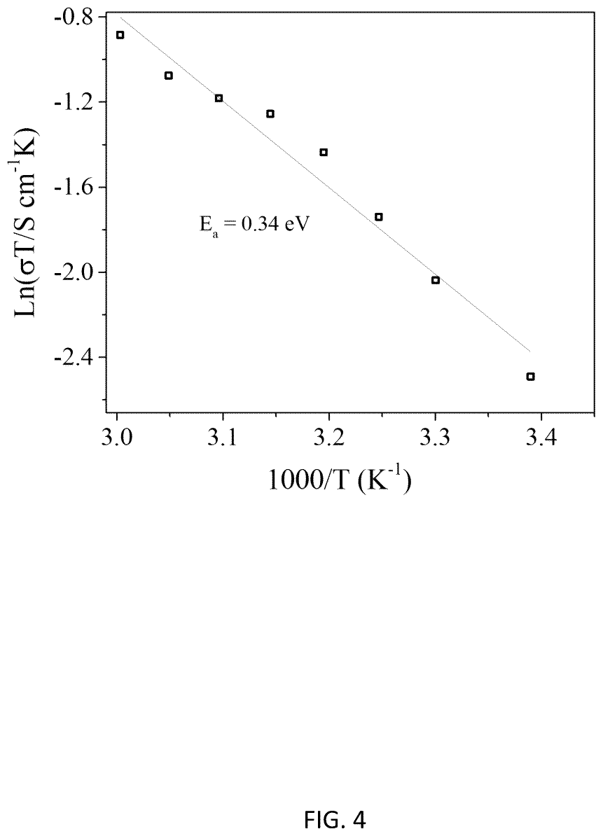

FIG. 5 is an SEM analysis of surface and cross-section SEM images of Al-LLZO ceramic disc at sintering temperature ranging from 1100-1280° C., sintered for an hour where the scale bars are 20 μm.

FIG. 6 is a series of EIS spectra of Al-LLZO pellets sintered at 1280° C. with Au as blocking electrodes for 5 different coin cell samples.

FIG. 7 is a graph of Al-LLZO pellets sintered at lower temperature of 1100° C., and

FIG. 8 is a graph of the bulk resistance response to change in temperature of Al-LLZO pellets sintered at 1280° C. for an hour.

FIG. 9 is a graph of wetting behavior and interfacial contact characterization of Li| garnet SSE and Li|Si₃N₄-coated garnet SSE, with Si₃N₄ deposited Al-LLZO pellet with molten Li on top with contact angle (θ_{c}<90°).

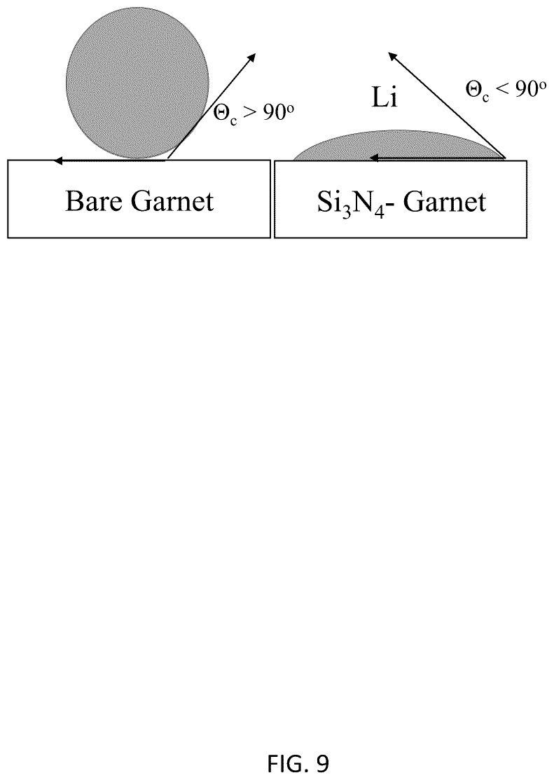

FIG. 10 is a graph of wetting behavior and interfacial contact characterization of Li| garnet SSE and Li|Si₃N₄-coated garnet SSE showing an XRD comparison of thus prepared bare garnet and Si₃N₄-coated garnet.

FIG. 11 is a series of cross-section SEM images of Li/Al-LLZO interface without and with a Si₃N₄ interlayer.

FIG. 12 is a series AFM mapping of bare and Si₃N₄ modified Al-LLZO garnet pellet SSE surface.

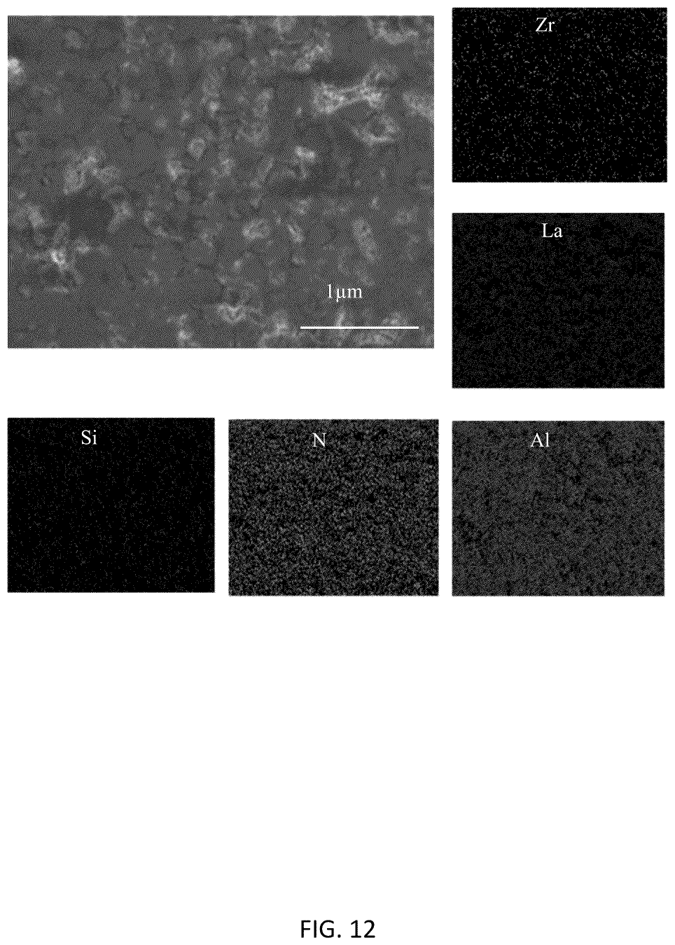

FIG. 13 is a pair of images of is bare garnet and a Si₃N₄ modified garnet.

FIG. 14 is a graph of the Nyquist plots of Li-symmetrical cells for Al-LLZO with and without Si₃N₄ modification.

FIG. 15 is a graph of galvanostatic cycling performance of Li/Al-LLZO/Li symmetrical cells with and without Si₃N₄ modification at 0.05 mA cm⁻², 0.05 mAhcm⁻² for the first few cycles.

FIG. 16 is a graph of galvanostatic cycling performance of Li/Al-LLZO/Li symmetrical cells with and without Si₃N₄ modification at 0.05 mA cm⁻², 0.05 mAhcm⁻² for long term cycling.

FIG. 17 is a graph of galvanostatic cycling performance of Li/Si₃N₄/Al-LLZO/Si₃N₄/Li symmetric cell at constant current density of 0.1 mA cm⁻².

FIG. 18 is a graph of the optimization of interlayer thickness by evaluating the cycling stability of Li/garnet/Li symmetrical cells at 0.1 mA cm⁻² with a Si₃N₄ thickness of 0 nm (bare garnet), where the cell short circuits after 15 hours of cycling.

FIG. 19 is a graph of the optimization of interlayer thickness by evaluating the cycling stability of Li/garnet/Li symmetrical cells at 0.1 mA cm⁻² with a Si₃N₄ thickness of 20 nm, showing plating/stripping cycles becomes unstable with rapid increase in overpotential voltage after 150 hours of cycling.

FIG. 20 is a graph of the optimization of interlayer thickness by evaluating the cycling stability of Li/garnet/Li symmetrical cells at 0.1 mA cm⁻² with a Si₃N₄ thickness of 30 nm, showing cycling is stable for more than 700 hours.

FIG. 21 is a graph of the optimization of interlayer thickness by evaluating the cycling stability of Li/garnet/Li symmetrical cells at 0.1 mA cm⁻² with a Si₃N₄ thickness of 40 nm, showing the cell short circuits after 100 hours of cycling;

FIG. 22 is a graph showing galvanostatic plating/stripping cycles of 30 nm Si₃N₄ deposited garnet SSE at 0.2 mA cm⁻², 22° C. compared with that for bare garnet.

FIG. 23 is a graph showing the first few cycles showing stable plating at 0.2 mA cm⁻² for 30 nm Si₃N₄ deposited garnet whereas unstable plating for bare garnet.

FIG. 24 is a cross-section SEM of short-circuited symmetrical cells after galvanostatic cycling showing Li infiltration in SSE garnet pellet.

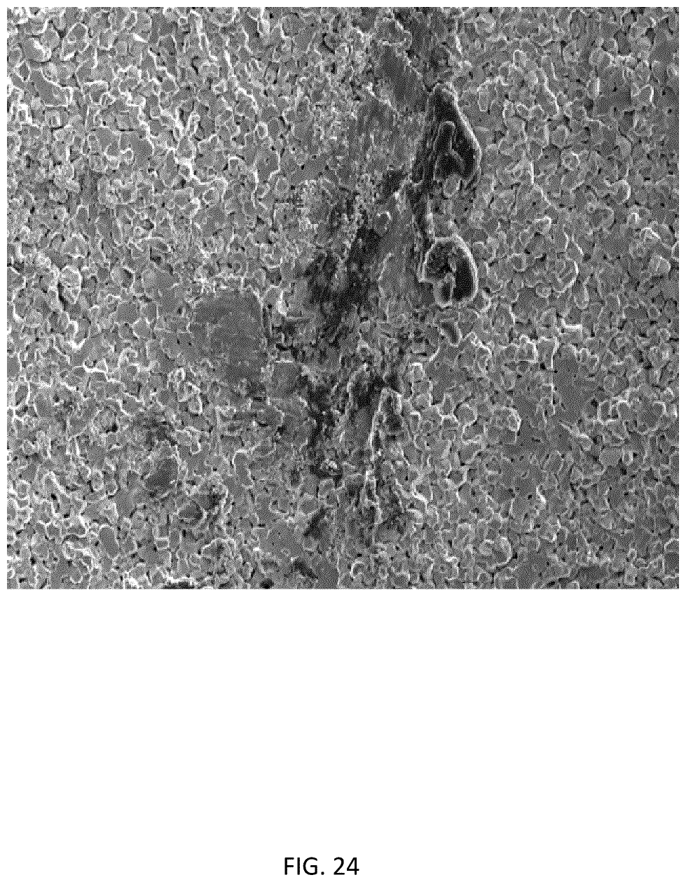

FIG. 25 is a schematic of device structure for Li/Si₃N₄@Al-LLZO/LFP cell.

FIG. 26 is a graph of the cycling performance of the cell at 0.2 C-rate, room temperature.

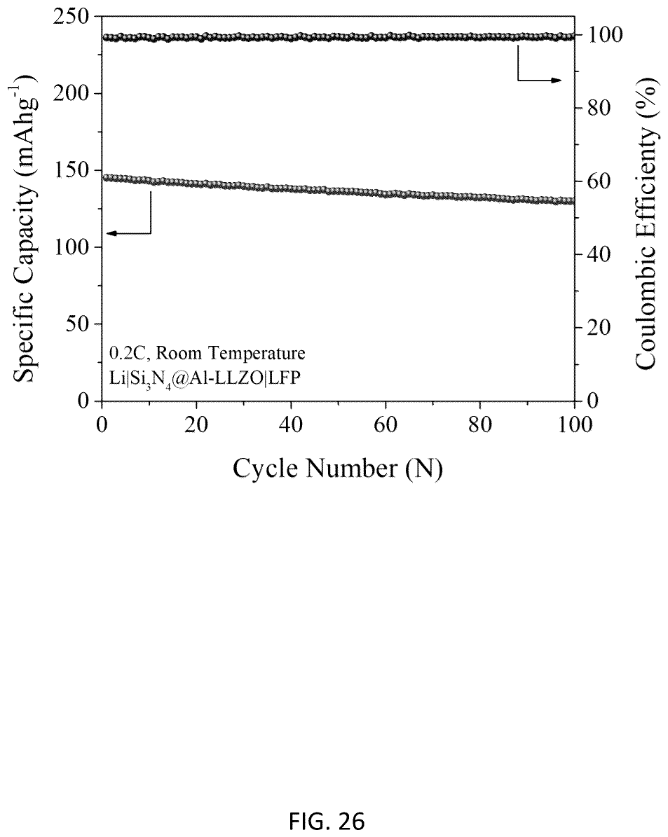

FIG. 27 is a graph of the voltage profiles for selected cycles (1^{st}, 50^{th}, and 100^{th}) of Li/Si₃N₄@Al-LLZO/LFP cell at 0.2 C, room temperature.

FIG. 28 is a graph of the rate performance of cell at different C-rates.

FIG. 29 is a Nyquist plot of full cells with bare garnet and Si₃N₄ modified garnet.

FIG. 30 is a graph showing a comparison of full cell performance between bare garnet and Si₃N₄ modified garnet.

### DETAILED DESCRIPTION OF THE INVENTION

Referring to the figures, wherein like numerals refer to like parts throughout, the present invention comprises a novel nitride interface modifier by coating the garnet type Li_{6.25}Al_{0.25}La₃Zr₂O₁₂ (Al-LLZO) solid electrolyte with thin layer of Si₃N₄ deposited by Radio Frequency (RF) sputtering technique. This interfacial buffer layer enabled establishment of a homogeneous and intimate physical contact between the SSE and Li°. The developed nitride interface, denoted as Si₃N₄@Al-LLZO, showed stable interface during cycling of symmetrical cells for prolonged period of more than 800 hours. With optimization of the Si₃N₄@Al-LLZO interfacial layer, Li/Si₃N₄@Al-LLZO/LFP full cells showed excellent overall cycling and rate performance.

### Structure, Composition, and Kinetics of Prepared SSE

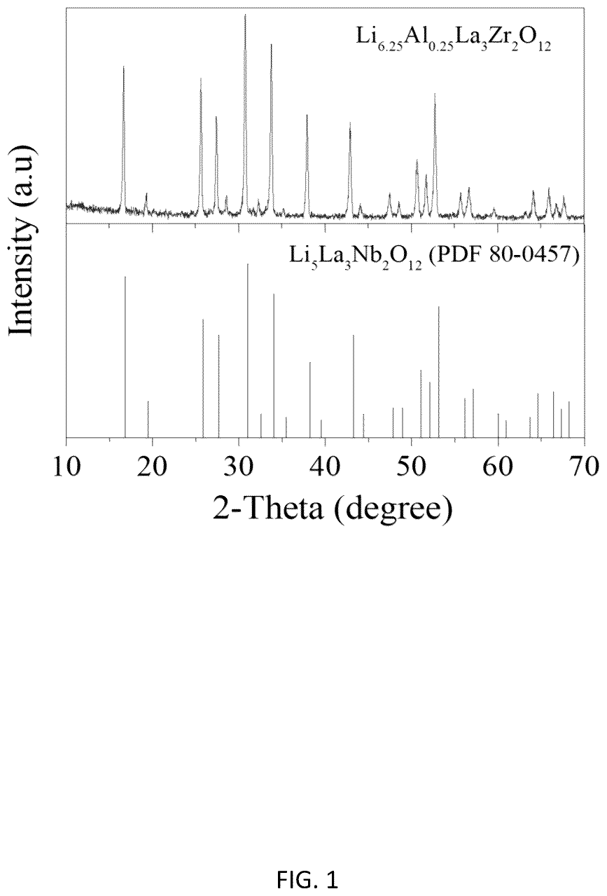

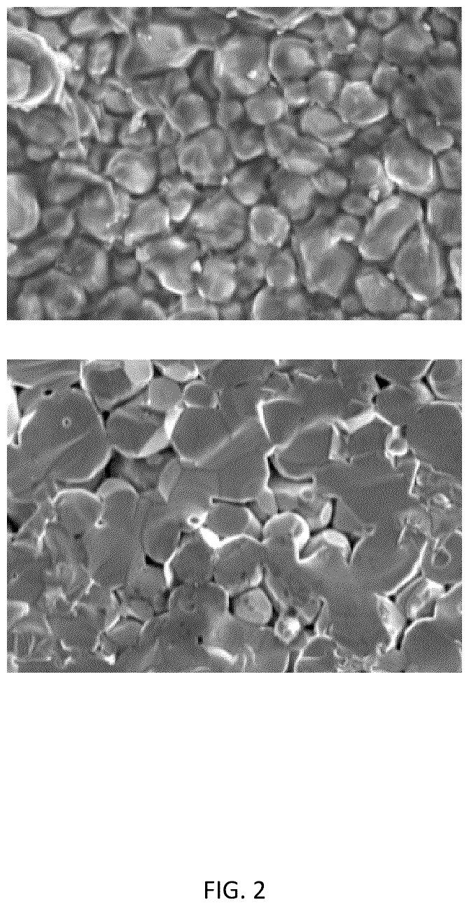

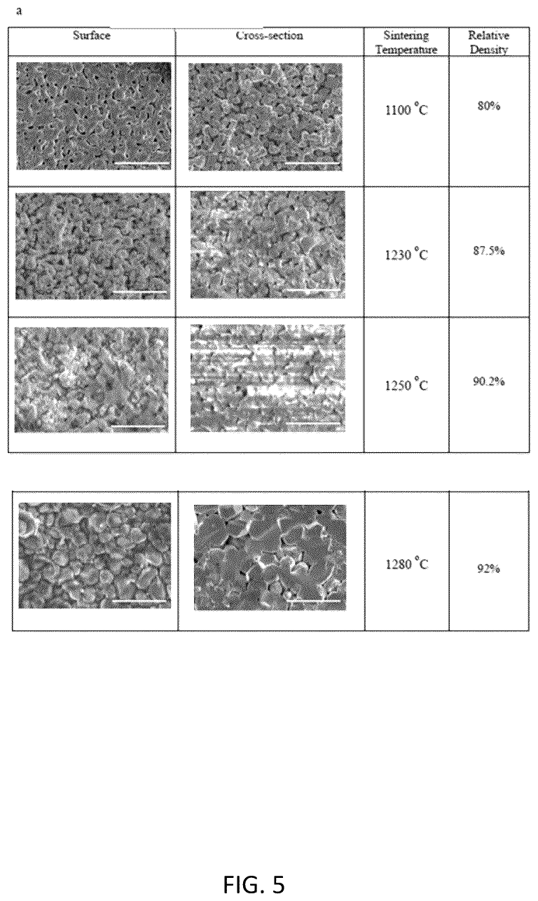

The cubic phase Li_{6.25}Al_{0.25}La₃Zr₂O₁₂ garnet nanopowder was pressed, sintered, and polished into solid-electrolyte pellets. XRD patterns (FIG. 1) of as prepared solid electrolyte pellets shows the resemblance of diffraction peaks when indexed to the standard pattern of cubic garnet phase Li₅La₃Nb₂O₁₂ (PDF #80-0457). Different sintering temperatures were applied (FIG. 5) for the purpose of obtaining densified pellets. The surface and cross-section SEM images (FIG. 2) shows well densified pellets with majority of grains tightly connected when sintered at 1280° C. for an hour. These sintered pellets have relative densities of ˜92% when measured using Archimedes' principle and ethanol as immersion medium. Grain amalgamation can be seen in most of the areas, which suppresses the formation of grain boundaries, while in some areas, pores are still visible because of less than 95% relative density.

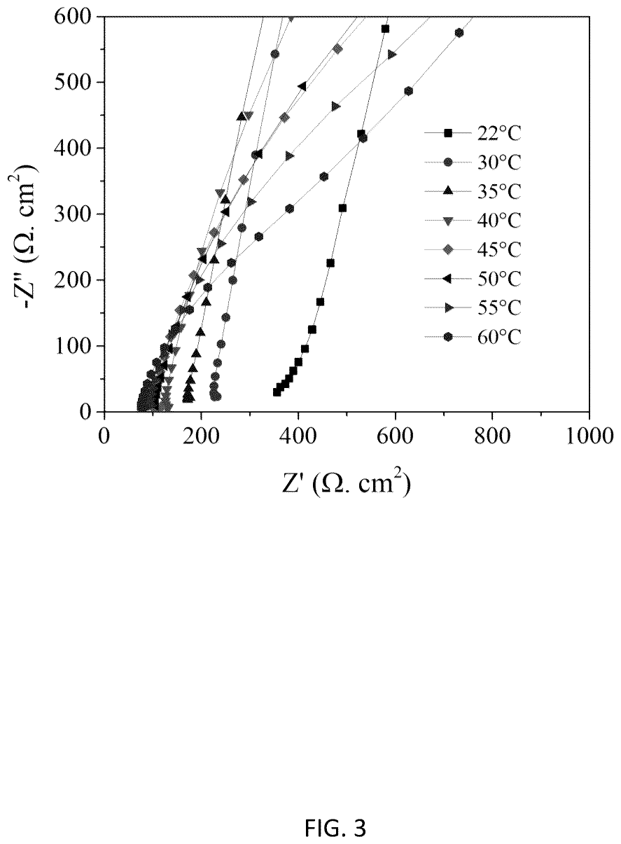

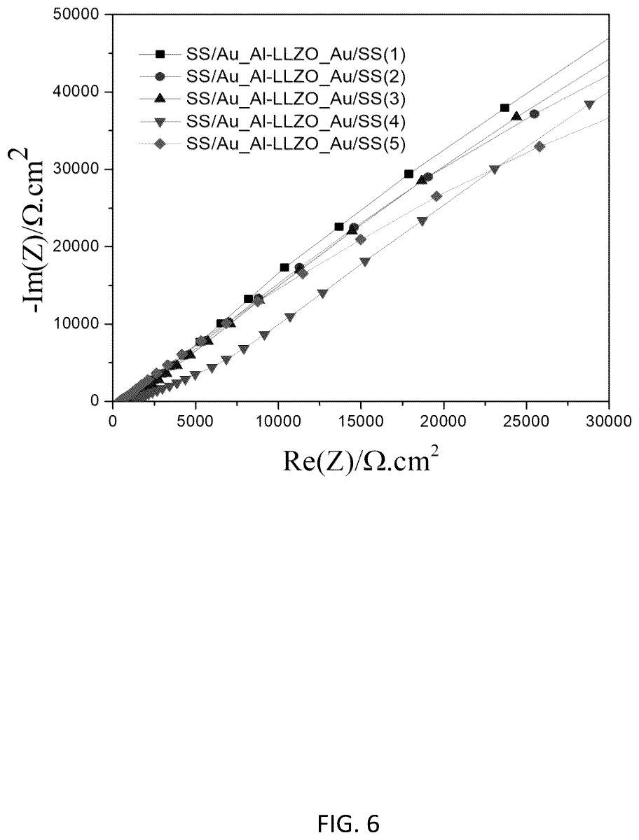

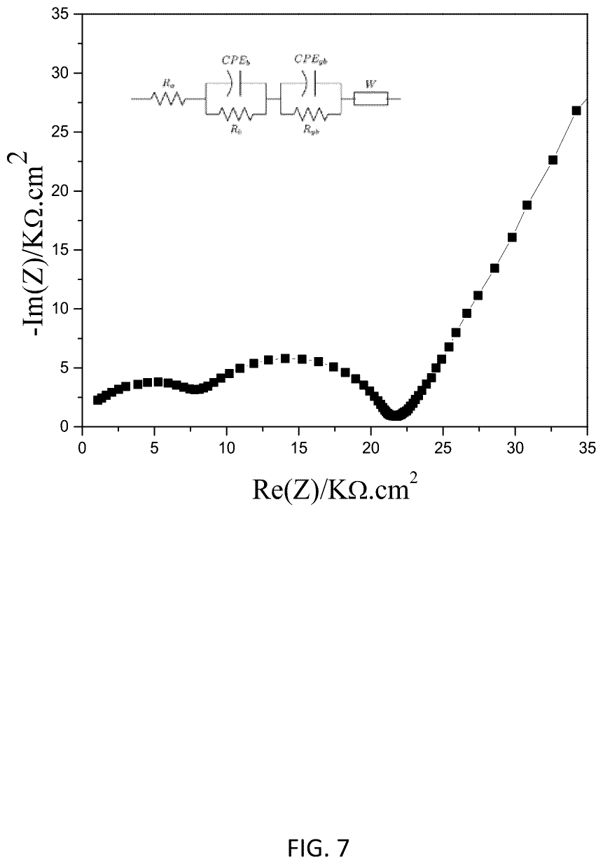

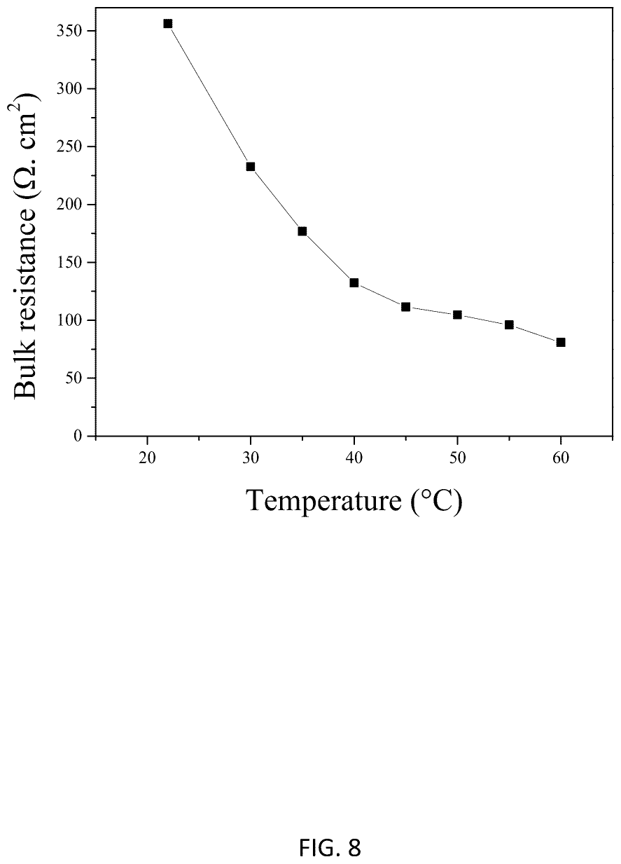

The ionic conductivity of Al-LLZO pellets were evaluated using electrochemical impedance spectra (EIS) with Au layers as blocking electrodes. As observed in FIG. 6 when pellets were sintered at 1280° C. the Nyquist plot shows mainly the bulk response whereas the grain boundary contribution appears negligible compared to samples sintered at lower temperature of 1100° C. (FIG. 7) where two clearly visible semicircles indicate presence of significant grain boundary resistance. The tail arising at low-frequency in both of these cases is attributed to Warburg impedance from the capacitive behavior of gold (Au) blocking electrodes. The total Li-ion conductivity of Al-LLZO pellets using the low-frequency intercept value is calculated to be 2.81×10⁻⁴ Scm⁻¹. The Li-ion conductivity of Al-LLZO was also measured at temperatures ranging from 22 to 65° C. (FIG. 3), where the low-frequency intercept value decreases (FIG. 8) by following typical Arrhenius behavior. Activation energy (Eₐ) for Li-ion conduction can be calculated from (equation 1):

$$σ = \frac{A}{T} exp ( \frac{- {E}_{a}}{{k}_{b} T} ) \qquad ( 1 )$$

where A is pre-exponential factor, Eₐ is the activation energy, k_{b} is the Boltzmann constant, and T is the absolute temperature. Thus, observed activation energy and Li-ion conductivity of 0.34 eV and 2.81×10⁻⁴ Scm⁻¹ at 22° C., respectively are in line with other reports for garnet SSE.

### Metal Nitride Interface Layer Properties

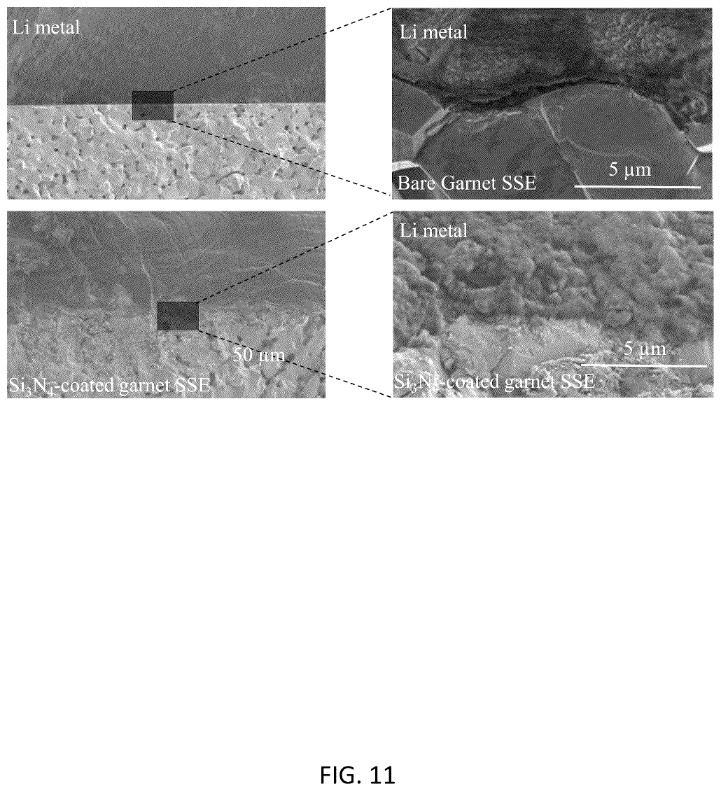

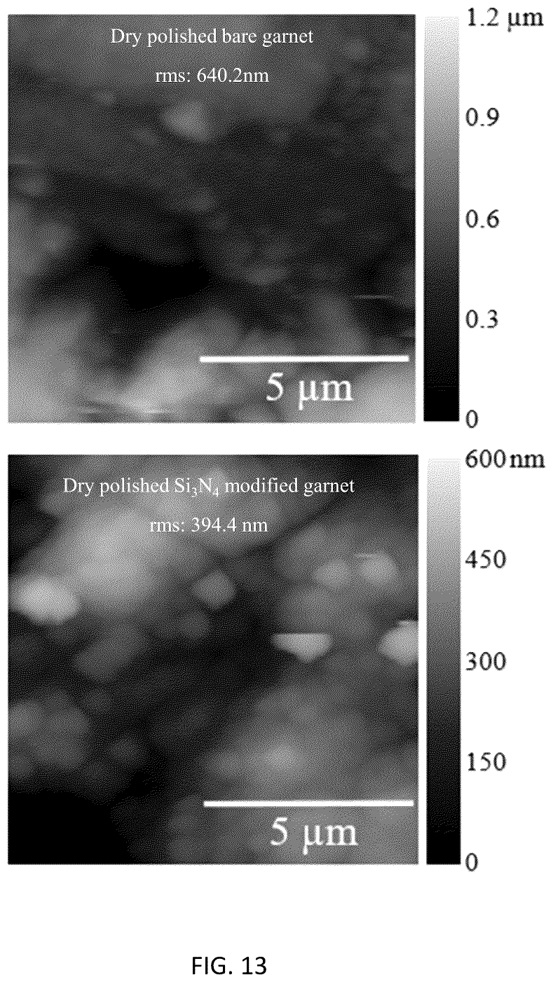

The improved interfacial contact between Li° and Al-LLZO garnet electrolyte is crucial for enhanced ion transport and even current distribution at the interface. However, as seen in SEM images of FIG. 11, the contact between Li° and bare garnet consists of voids and gaps leading to uneven current distribution at the interface that accelerates dendrite or dead Li° growth that could short-circuit through the solid electrolyte. To address this issue, a thin film of Si₃N₄ was sputter deposited on top of Al-LLZO garnet pellet. FIG. 6a shows the Energy-dispersive X-ray spectroscopy (EDS) spectrum and mapping of Si₃N₄ deposited Al-LLZO garnet pellet, which reveals the presence of La, Zr and Al in the garnet along with N and Si attributed to the deposited Si₃N₄. Further, atomic force microscopy (AFM) performed on bare (FIG. 13 top) and Si₃N₄ modified (FIG. 13 bottom) garnet samples compares their surface roughness values using the average surface root mean square (RMS) values, which reveals the presence of Si₃N₄ significantly reduces the RMS value from 640.2 nm of bare garnet to 394.4 nm. The higher RMS value represents uneven and rough surface of dry polished bare garnet that leads to poor contacts and induces uneven current distribution that eventually leads to preferential deposition of Li° on certain spots and formation of dendrites. The lower RMS value of Si₃N₄ modified dry polished garnet should result in much more uniform and stable Li plating/stripping that is conducive for longer cycling life.

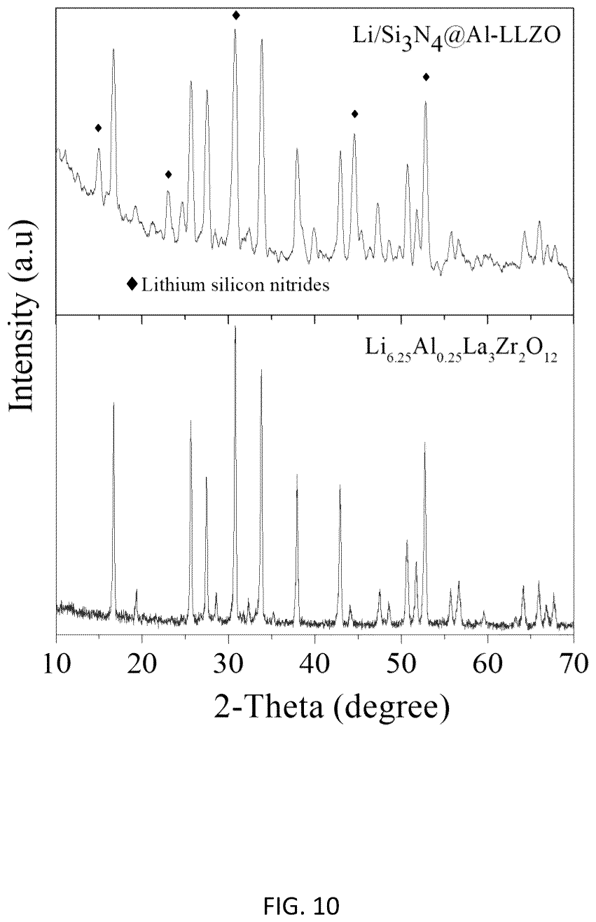

After Si₃N₄ thin film deposition, as shown in SEM images of FIG. 11, the Li anode has been tightly soldered with Al-LLZO pellet as no gaps and voids is visible in comparison to bare garnet. This depicts that the Si₃N₄ thin film at the interface enabled the promotion of interfacial contact of Al-LLZO grains with Li°, thus effectively enhancing the physical contact. To observe the lithiophilicity of Si₃N₄ interfacial layer, molten Li° droplet was applied to the bare and Si₃N₄ coated garnet pellets, respectively. The molten Li° on the top of bare garnet pellet instantly beads up to form a ball revealing lithiophobic nature of Al-LLZO garnet. In contrast, with Si₃N₄-coated garnet, the molten lithium readily wets the garnet surface and spreads out to fully cover it. To further demonstrate this conversion of lithiophobicity to lithiophilicity by Si₃N₄ thin layer, a simple experiment was performed, where Li⁰ foil was gradually heated on the top of the Si₃N₄-coated garnet surface. When Li metal starts to melt at ˜190° C., the Si₃N₄-coated area in proximity to Li⁰ turns black in color which suggests occurrence of lithiation reaction of as-deposited Si₃N₄. This reaction not only occurred at the areas directly under Li⁰ but also around the entire Si₃N₄-coated garnet. XRD was performed after Si₃N₄ deposition on SSE pellet and infusing molten lithium on top of it, FIG. 10 shows appearance of some new peaks indicated as f along with the common diffraction peaks related to Al-LLZO. These pronounced new peaks indicate the formation of lithium silicon nitrides (JCPDS #01-077-2882) when lithium reacts with silicon nitride layer at the interface and can also be verified from previous literatures. Studies have shown the thermal formation of different ternary lithium silicon nitrides from Si₃N₄ when in contact with Li. This gives validity to the assumption that the formation of a ternary phase is favored energetically. The formation of ternary phase alloys of lithium silicon nitrides at the interface provides open tunnels for Li⁺ conduction as all phases of these alloys are shown to conduct Li⁺ where phase such as Li₈SiN₄ can show conductivity reaching as high as 5×10⁻² Sm⁻¹ at 400 K with lowest activation energy (46 kJ/mol). Based on these hypotheses, the chemical equation of following form that can best describe the initial reduction reaction for thin film system is proposed:

$${nSiN}_{x} + {yLi}^{+} + {ye}^{-} \to {naLi}_{3.5} Si + {nLi}_{b} {Si}_{1 - a} {N}_{x} + {cALi}^{SEI} \qquad ( 1 )$$

The final term, in chemical equation (1) shows the consumption of lithium while forming solid electrolyte interphase (SEI) layer at the interface. Thus, the conversion reaction of Si₃N₄ film deposited at interface with Li can result in formation of ternary phase alloy such as Li₂SiN₂ which can enhance the interfacial contact.

Furthermore, coating amorphous silicon (Si) have been known to switch the surface of garnet LLZO from “superlithiophobic” to “superlithiophilic”. Similarly, lithium nitride (Li₃N) in case of both garnet solid and liquid electrolyte have been shown to drastically decrease the interfacial impedance and passivate the surface of Li anode. Based on these previous findings silicon nitride (Si₃N₄) is propitious to show both strong wetting interaction with molten Li° due to the presence of nitride that undergoes alloying reaction to form Li₃N passivating layer on the garnet electrolyte surface.

### Electrochemical Properties of Interface Stabilized SSE

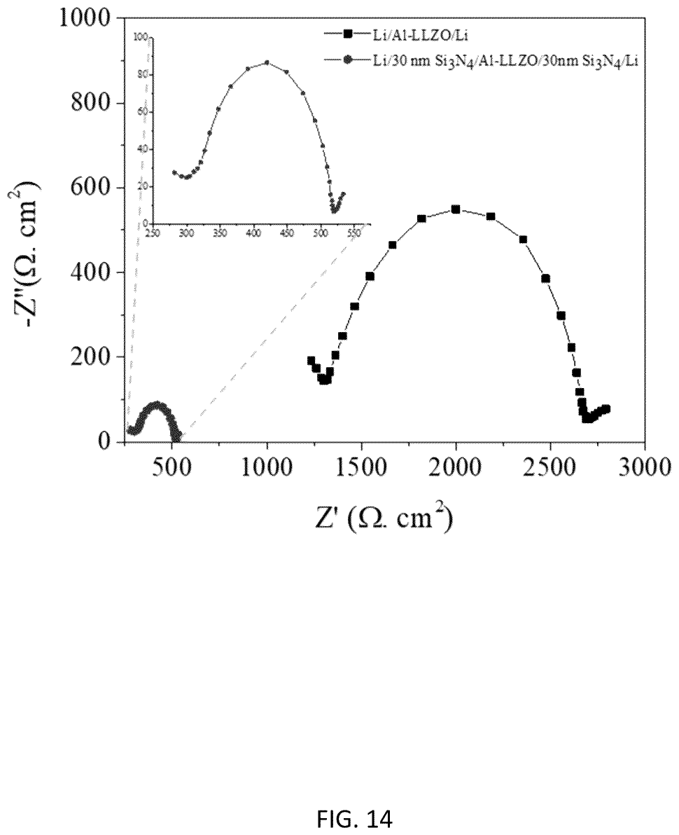

Symmetric cells Li/Si₃N₄/Al-LLZO/Si₃N₄/Li and Li/Al-LLZO/Li were assembled and characterized, whose Nyquist plots (FIG. 8a) shows that the introduction of Si₃N₄ reduces total impedance (combined impedance of Al-LLZO electrolyte pellet and Li/Al-LLZO interface) from 2750 Ωcm² for the bare garnet to 525 Ωcm² for the modified one (FIG. 14). The total (bulk+grain boundary) impedance for Al-LLZO pellet samples was obtained by EIS measurements of Au/Al-LLZO/Au blocking electrode symmetric cells. At 22° C., the total impedance of Au/Al-LLZO/Au sample was observed to be 356 Ωcm². Judging from the values from FIG. 8a for combined impedances of symmetric Li/Al-LLZO/Li cells both in presence and absence of Si₃N₄ interlayer, the interfacial ASR has been reduced from 1197 Ωcm² to 84.5 Ωcm². This significant reduction of interfacial ASR can be attributed to: (1) Si₃N₄ interlayer promoting conformal contact of Li anode on SSE which further increases the effective ionic transfer area; (2) formation of thermally lithiated Si₃N₄ when Li metal is heated in contact with the interlayer; and (3) inhibition of impurity layers, such as, Li₂CO₃ due to coating of Si₃N₄ on SSE surface.

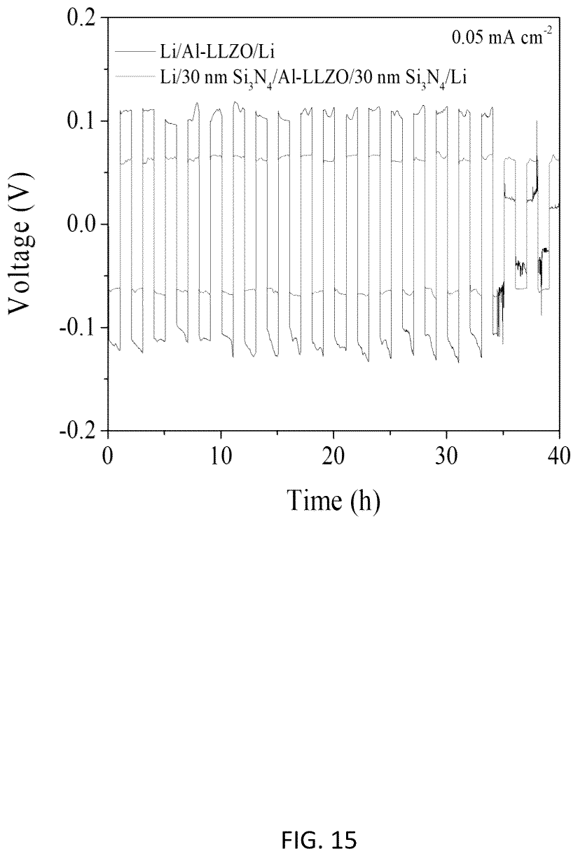

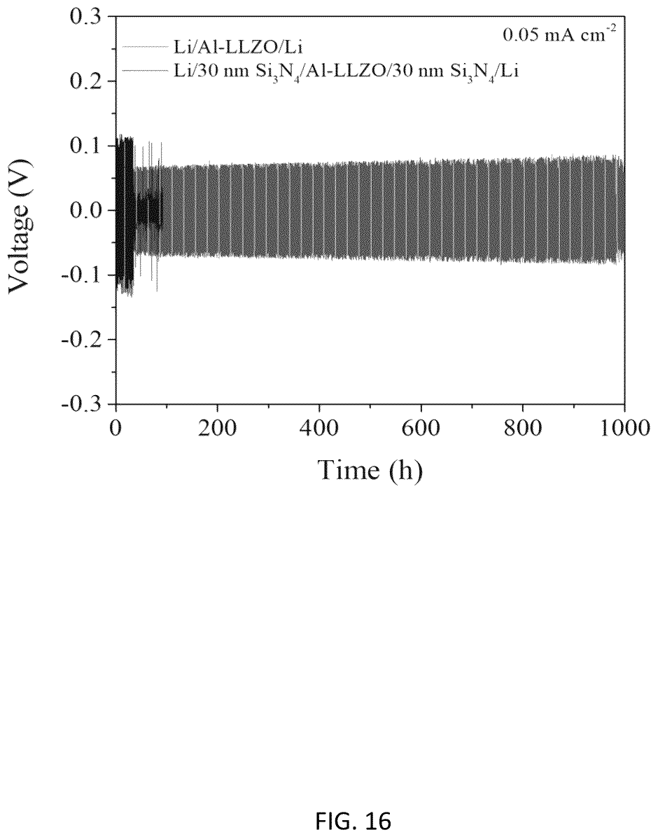

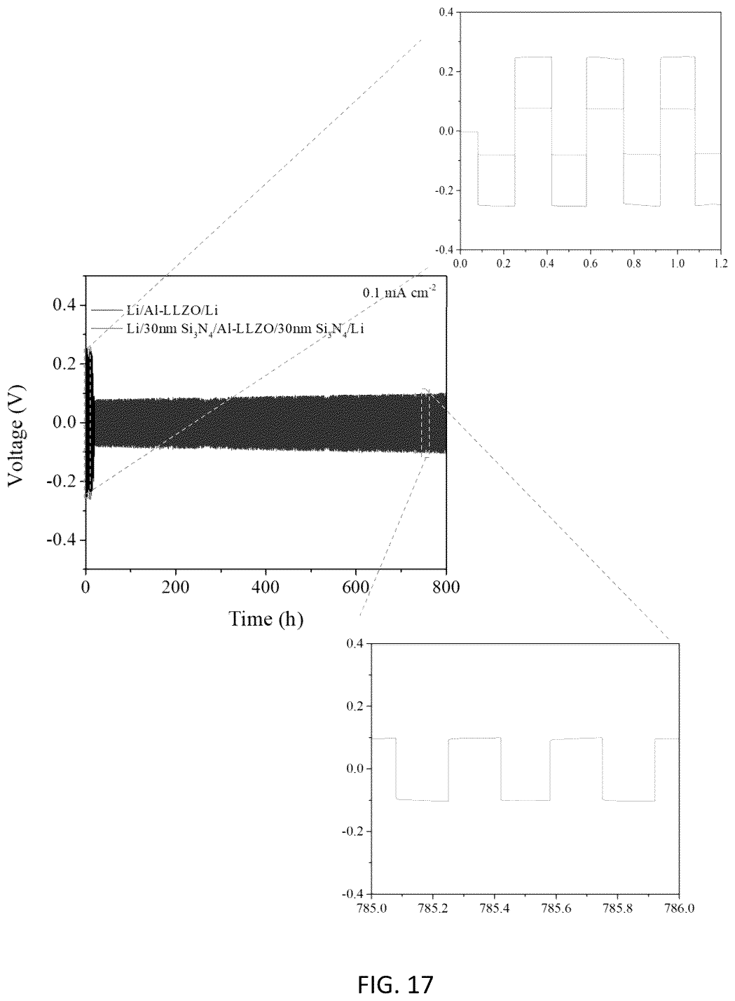

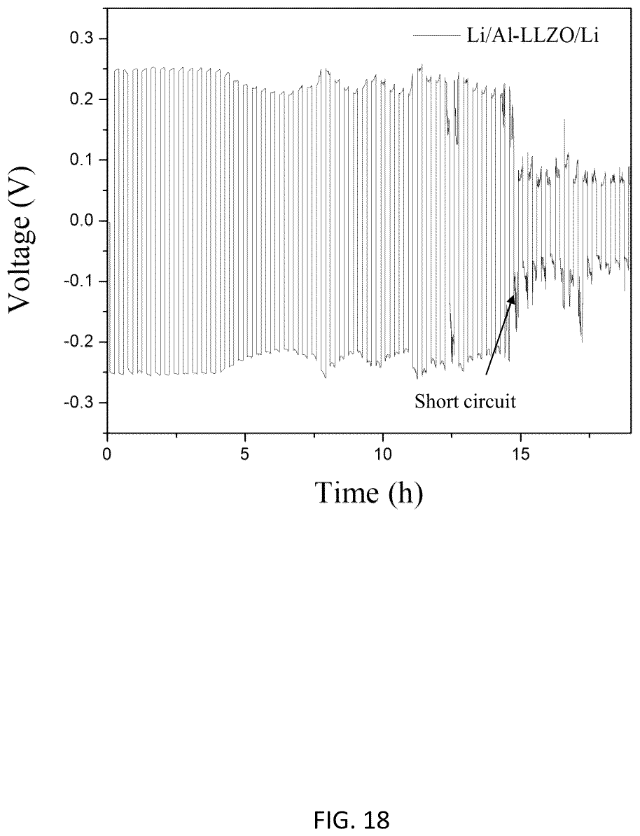

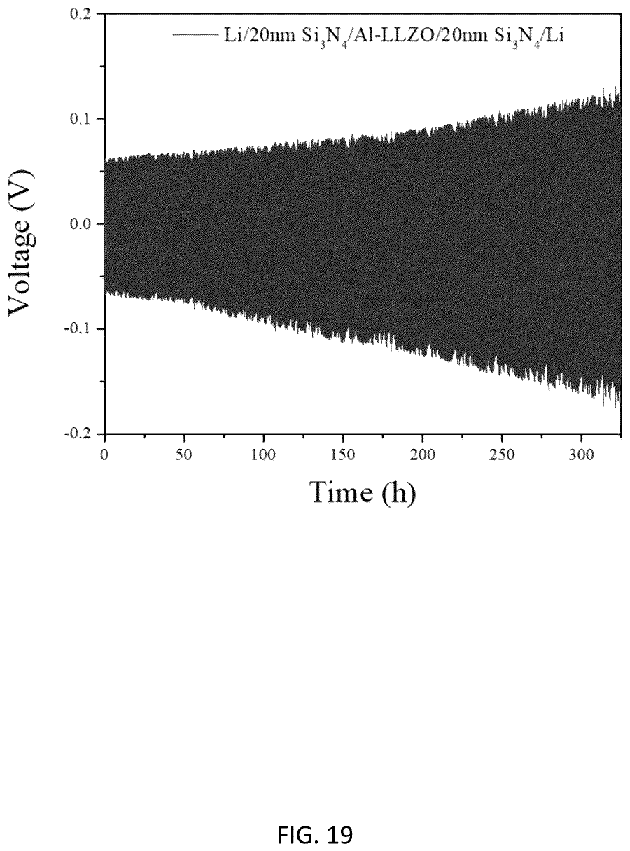

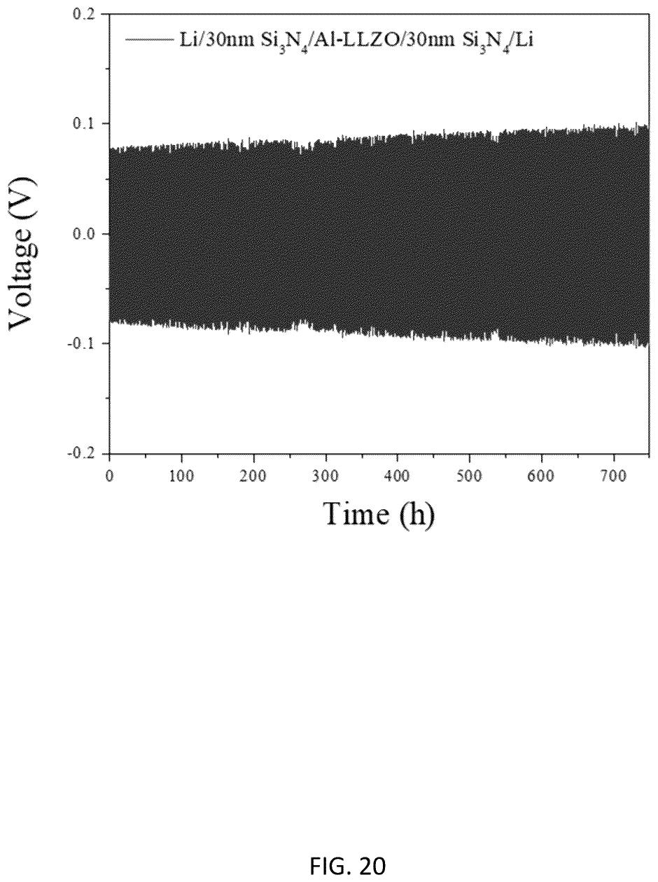

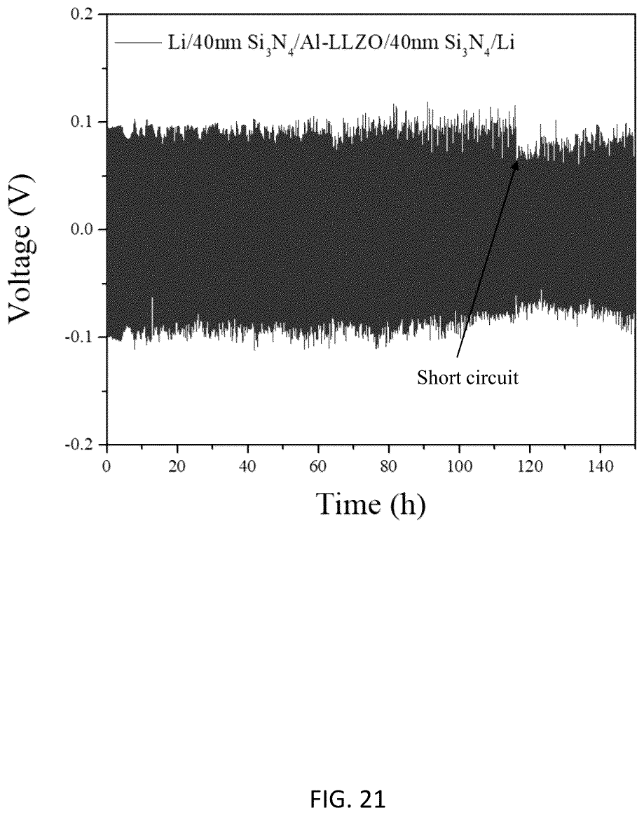

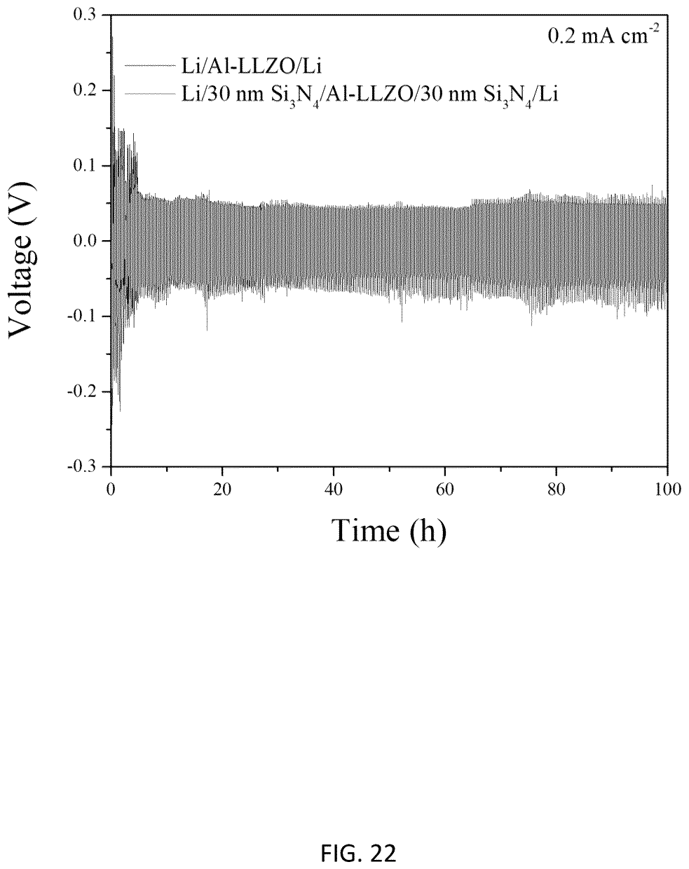

Galvanostatic Li plating/stripping cycling experiments using Li symmetrical cells were performed to assess the effectiveness of Li-ion transport across the interface and cycling stability. For this, various thicknesses of Si₃N₄ (for example 20, 30 and 40 nm) interlayer were deposited on top of Al-LLZO garnet surface. These Li-symmetrical cells for optimizing Si₃N₄ thickness were cycled under constant current density of 0.1 mAcm⁻². As shown in FIG. 18, the symmetrical cell with bare garnet short circuited after only 15 hours of cycling. In comparison, when 20 nm of Si₃N₄ interlayer was introduced (FIG. 19), the plating/stripping cycles become very stable until 150 hours. While 30 nm deposited Si₃N₄ interlayer (FIG. 20) shows the optimum stable plating/stripping cycles for more than 700 hours, where further increase in thickness of Si₃N₄ interlayer to 40 nm limited the cycling to 100 hours (FIG. 21). As shown in FIGS. 14-21, plating-stripping cycles of symmetrical cells were performed in both low and high current densities of 0.05 mA cm⁻² and 0.2 mA cm⁻², respectively. FIG. 15 shows comparison of first few plating/stripping cycles of Li symmetrical cells based on bare garnet and Si₃N₄-modified garnet cycled at current density of 0.05 mA cm⁻² and capacity 0.05 mAh cm⁻². It can be observed that the symmetric cell with bare garnet is plagued with large overpotential >±100 mV, while the cell with Si₃N₄ interface layer facilitated the suppression of this overpotential to ±60 mV. This indicates that the introduction of Si₃N₄ reduced the energy barrier of lithium transfer process at the interface, thus facilitating the occurrence of efficient plating/stripping cycles. Longer plating/stripping cycling of these symmetrical cells was carried out as shown in FIG. 16. The cell with bare garnet short circuits after only 35 hours, which can be attributed to typical phenomenon of Li infiltration into SSE (FIG. 22). In contrast, the cell with Si₃N₄-modified garnet shows stable cycling for 1000 hours, suggesting stable interface enabled by Si₃N₄ thin film. Similar stable cycling up to 800 hours at current density of 0.1 mAcm⁻² was demonstrated by the Si₃N₄-modified garnet with voltage stabilized at ˜80 mV (as further indicated by voltage profiles in inset of FIG. 17), while the cell with bare garnet could last only 20 h with large voltage polarization of ˜250 mV.

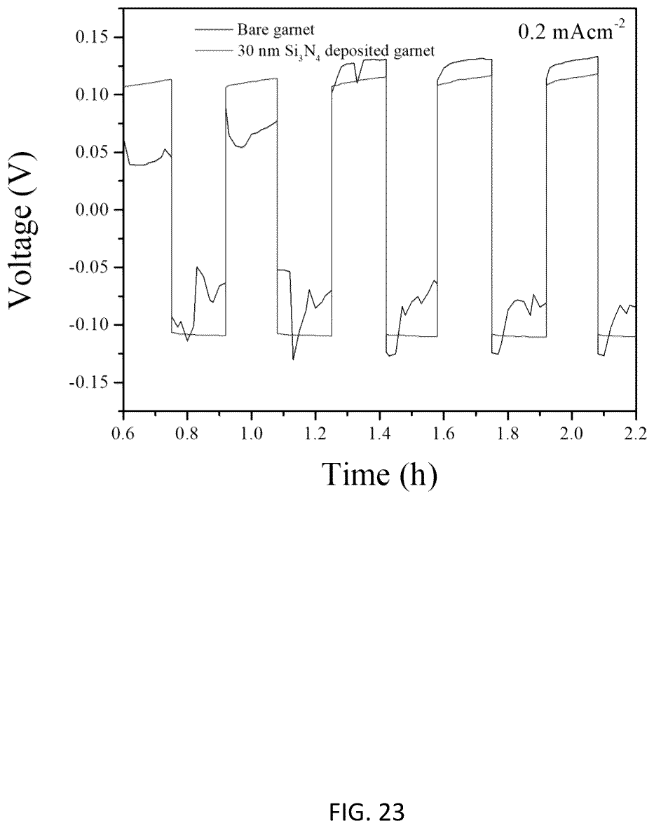

This excellent cycling with low voltage polarization confirms the establishment of a stable interface with low interfacial impedance by introduction of Si₃N₄ interfacial layer. Also, longer and stable cycling with almost unchanged polarization and overpotential of ˜100 mV was exhibited at higher current density of 0.2 mAcm⁻² (FIGS. 22 and 23). Using Ohm's law, the total resistance of these symmetrical cells is calculated to be 500 Ωcm⁻² which is close to total resistance obtained from EIS of ˜525 Ωcm⁻² (FIG. 14). This difference is attributed to the temperature factor, as the EIS test was performed at room temperature. The prompt short circuiting of bare garnet compared to garnet with Si₃N₄ modified interface, shows that superior stability of interface is attained by Si₃N₄ deposition as interlayer. This enhanced interface stability can be due to formation of Li₃N and other ternary phase alloys of lithium, silicon, and nitrogen, which are regarded as artificial SEI layers. These observations imply that Si₃N₄ coating as interlayer can homogenize current distribution at Li/garnet interface by addressing the interface mismatch between Li-anode and SSE.

### Full Cell Demonstration of Interface Stabilized SSE

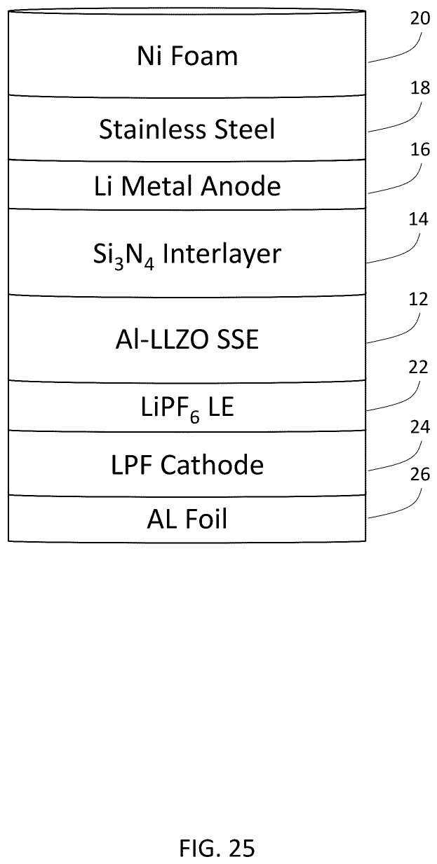

Further, to demonstrate the potential to enable high-energy density Li-metal batteries by the interface stability approach developed in this work, Li/Si₃N₄@Al-LLZO/LFP hybrid solid state full cells as shown in FIG. 25 were assembled and tested. A garnet electrolyte 12 was provided with a silicon nitride interfacial layer 14 on the surface coupled to a lithium metal anode 16. A layer of stainless steel 18 and a nickel foam 20 were provided on lithium metal anode 16. The opposing side of garnet electrolyte 12 was treated with a layer of lithium hexafluorophosphate 22 and coupled to a lithium iron phosphate (LPF) cathode 24. The cathode/garnet interface (Si₃N₄@Al-LLZO/LFP) was wetted with a tiny amount of liquid organic electrolyte to reduce cathode/electrolyte interfacial resistance. An aluminum foil 26 was provided on cathode 24.

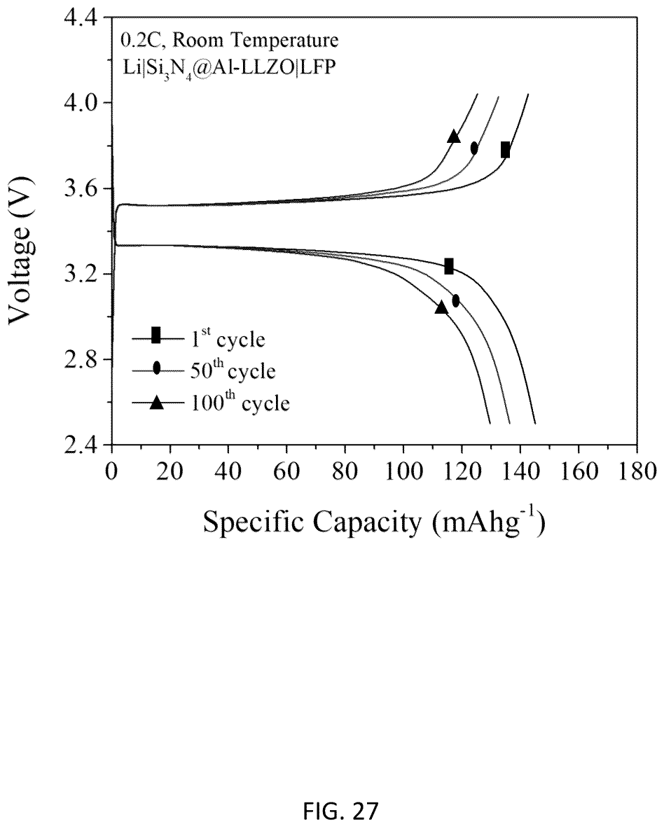

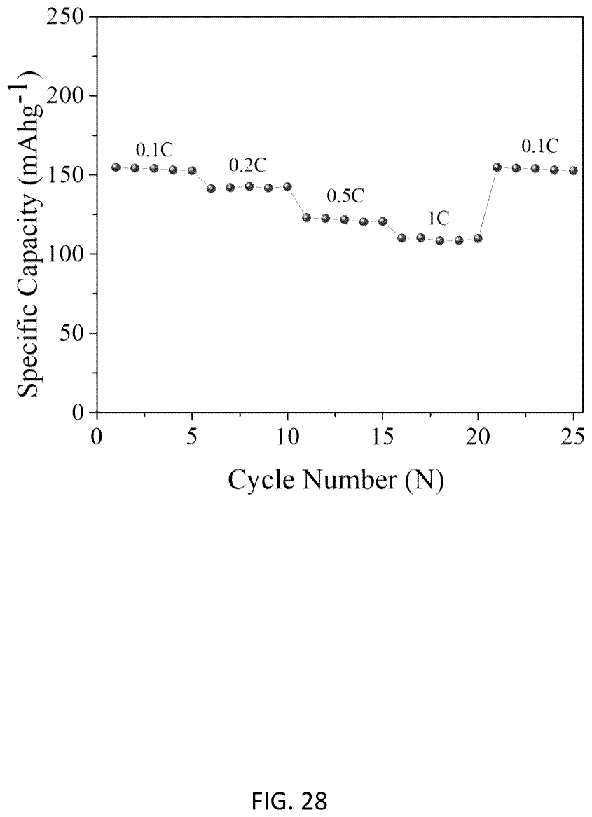

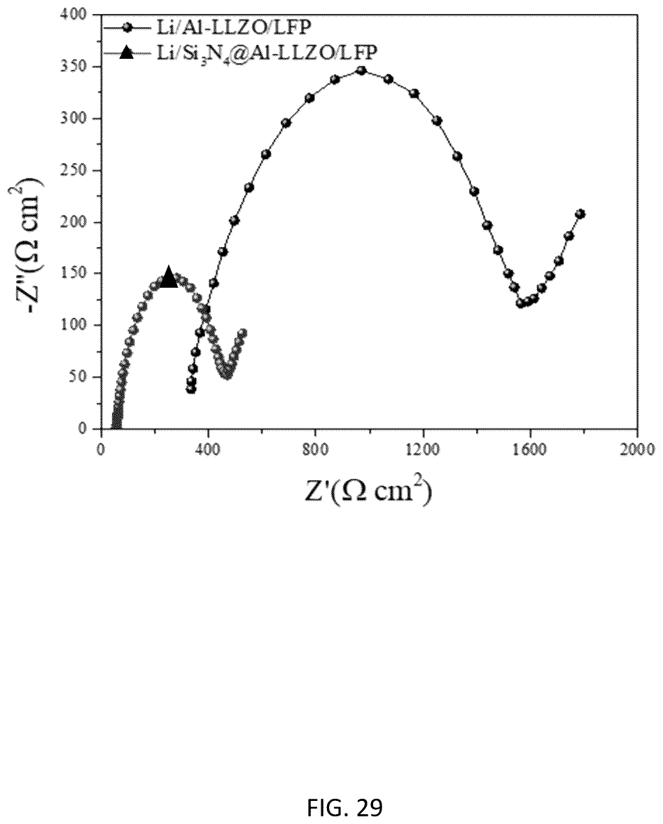

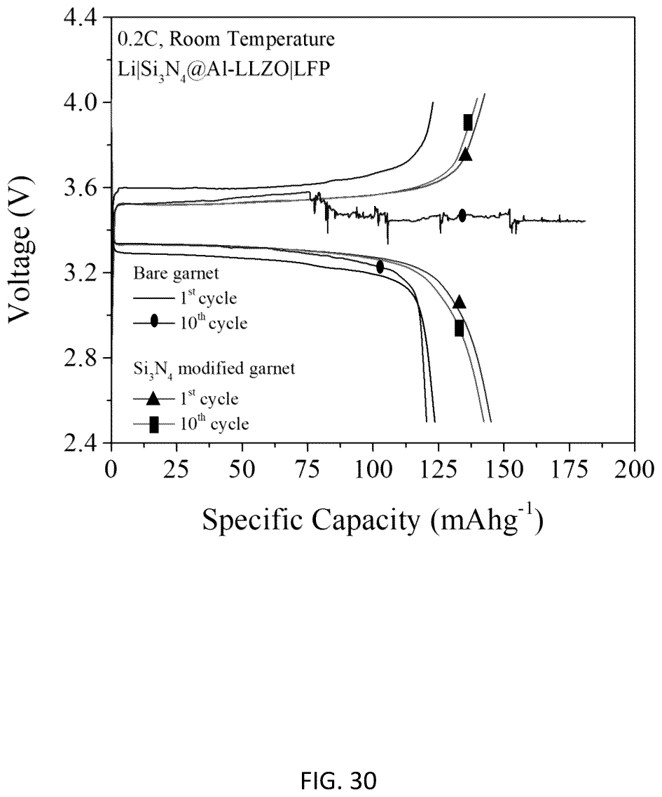

First, the EIS test of these hybrid solid-state full cells was performed. As shown by the Nyquist plots (FIG. 29), the total area specific resistance of full cell with Si₃N₄ modified Al-LLZO garnet electrolyte is <500 Ωcm² versus ˜1600 Ωcm² with bare garnet at room temperature. FIG. 11b displays the galvanostatic charge/discharge cycling performance of full cell with Si₃N₄@Al-LLZO garnet electrolyte at current density of 0.2 C. The cell delivered initial charge and discharge capacities of 146.25 and 145.11 mAhg⁻¹, respectively that corresponds to the coulombic efficiency of 99.2%. The discharge capacity after 100 cycles was 130 mAhg⁻¹ while maintaining the coulombic efficiency close to 100%. As shown in FIG. 27, the full cell with Si₃N₄@Al-LLZO garnet electrolyte exhibits well-defined and flat voltage plateaus with small polarization of ˜0.15 V at 1^{st}, 50^{th} and 100^{th} cycles tested at 0.2 C and room temperature. In contrast, as depicted in FIG. 30, the full cell with bare Al-LLZO garnet electrolyte displayed larger overpotential compared to Si₃N₄ modified Al-LLZO garnet and unstable charge voltage curves at 10^{th} cycle, suggesting short-lived cycling. The full cell with Si₃N₄@Al-LLZO garnet was further cycled at various C-rates of 0.1, 0.2, 0.5 and 1 C. As shown in FIG. 28, the cell demonstrated good rate capability with discharge capacities of 153.8, 142.1, 121.7 and 109.5 mAhg⁻¹ obtained at 0.1, 0.2, 0.5 and 1 C, respectively. The cell displayed discharge capacity retention of 153.8 mAhg⁻¹ at 0.1 C which accounted for ˜100% of the initial capacity after five cycles each of higher C-rates. These observations further validate the efficacy of introducing Si₃N₄ as Li/garnet interface modifier to obtain stable, and high energy density solid-state Li-metal batteries.

The present invention addresses the poor interfacing between Li° and garnet-type Al-LLZO solid state electrolyte by introducing a sputter-coated thin Si₃N₄ intermediate layer. The Si₃N₄ coating on the Al-LLZO solid electrolyte pellet significantly reduces Li/Al-LLZO interfacial resistance from 1197 Ωcm² to 84.5 Ωcm², promotes better wettability of Li° with Al-LLZO garnet electrolyte and facilitates efficient charge transfer at the interface. Noticeably, symmetrical cells with much lower overpotential and long plating/stripping cycling for >800 h at current density of 0.1 mAcm⁻² were demonstrated using the Si₃N₄ modified Al-LLZO garnet-type solid electrolyte. Along with it, Si₃N₄@Al-LLZO solid electrolyte paired with Li metal as anode and LFP as cathode exhibited stable cycling performance with excellent coulombic efficiency compared to that for bare garnet. Introduction of Si₃N₄ facilitated formation of lithiophilic interface which in turn contributed to establishment of an intimate and conformal physical/chemical contact between garnet-type solid electrolyte and lithium. The present invention successfully resolves the primary challenge of high impedance Li/garnet-type solid electrolyte interface for solid-state batteries.

### EXAMPLE

Garnet Al-LLZO solid electrolyte pellets preparation. 0.4 g of cubic phase aluminum doped lithium lanthanum zirconate garnet nano-powder, Li_{6.25}Al_{0.25}La₃Zr₂O₁₂ (Ampcera Inc., 99.9%) was pressed into pellet by using ½″ dry pellet pressing die (MTI Corp.) and applying 80 MPa pressure using Hydraulic lab press (Carver Inc.). Thus, obtained pellets were carefully placed on Magnesium Oxide (MgO) crucible, covered with same mother powder and sintered in furnace (Mellen, Microtherm) at 1280° C. for 1 hour. After the pellets were left to cool down to room temperature, they were dry polished from 1000, 1500, 2000 to 3000 grit sized sandpapers using rotary tool set (Fire Mountain Gems and Beads, USA). The polished pellets were stored in argon-glove box for future use.

Si₃N₄ interfacial layer deposition. Thin films of Si₃N₄ were deposited on polished Al-LLZO pellets using RF sputtering. 2″ dia×0.125″ thick, 99.9% metals basis, Silicon (IV) nitride (Si₃N₄) with MgO binder (Alfa Aesar) was used as target. The sputtering process was carried out at deposition rate of 0.1 Ås−1 with 50 sccm constant flow of Argon (Ar) gas. Various thickness (20 nm, 30 nm and 40 nm) of Si₃N₄ thin films were investigated and the thickness was optimized to 30 nm.

Solid-state Li- Symmetrical cells and Hybrid solid state Full cells assembly. First, for analyzing the ionic conductivity and cycling stability of as prepared solid electrolytes, Li/Si₃N₄/Al-LLZO/Si₃N₄/Li symmetric cells were prepared by attaching the melted Li at 200° C. on both sides of electrolyte pellets. After natural cooling down the Li/Si₃N₄/Al-LLZO/Si₃N₄/Li sample was assembled into coin cells in argon filled glovebox. Control symmetric cells without interface modification were also assembled for comparison with the modified one. Secondly, for preparation of Li/Si₃N₄@Al-LLZO/LFP hybrid solid-state full cells, the as prepared Li/Si₃N₄@Al-LLZO sample was assembled with LiFePO₄ (LFP) as cathode in a coin cell. For this, the cathode slurry was prepared by mixing LFP powders with Super-P carbon black and polyvinylidene fluoride (PVDF) at the weight ratio of 80:10:10, respectively in N-methyl-2-pyrrolidone (NMP) solvent, using mortar and pestle. The as prepared slurry was coated onto an aluminum foil and then dried in vacuum oven at 120° C. overnight for thorough evaporation of the solvent. The dried cathode strips were then punched into circular disks with the active materials mass loading of ˜2 mg cm⁻². Lastly, for assembly of hybrid solid-state full cell a tiny amount of 10 μl liquid electrolyte (1.0 molL−1 LiPF₆ dissolved in ethylene carbonate (EC) and diethyl carbonate (DEC) in volume ratio of 1:1) was introduced between LFP cathode and solid electrolyte pellet to enhance the cathode/electrolyte interface contact. The other side of Al-LLZO pellet with no trace of liquid electrolyte was modified by Si₃N₄ deposition and melted lithium was soldered on the top of it. The as assembled full cell was sealed in a 2032-coin cell with nickel foam on the top for absorbing the excess pressure during crimping and avoid damage to solid electrolyte pellet. The assembly of symmetric cells and full cells were done inside an argon-filled glove box with moisture and O₂ level<1 ppm.

### Material Characterizations.

The crystal structure of the samples was examined by X-ray diffraction (XRD) using Rigaku SmartLab diffractrometer with Cu Kα radiation (λ=1.54178 Å). Surface topography of bare garnet and Si₃N₄ modified garnet pellets were measured by Agilent SPM 5500 atomic force microscope that is equipped with a MACIII controller and a RTESPA-525 Tip with resonance frequency of 75 kHz. To observe the morphology of the samples, scanning electron microscopy (SEM) characterization was carried out using Hitachi S-4300N SEM which was also equipped with energy dispersive spectroscopy (EDS). Electrochemical impedance spectroscopy (EIS) measurement was done using the Ametek VERSASTAT3-200 potentiostat electrochemical workstation. The measurement was performed over a working frequency range of 1 MHz to 100 mHz with an amplitude of 10 mV. To measure the ionic conductivity of Al-LLZO garnet-type pellet, 20 nm of gold (Au) layers were sputtered on both sides of the pellet as blocking electrode. Galvanostatic charge/discharge measurements of assembled coin cells were performed using LAND CT2001A system. The full cells were cycled at various current densities (e.g., 1 C=170 mA g⁻¹) in voltage range of 4.0-2.5 V. The coin cells were tested at room temperature.

What is claimed is:

1. A solid-state lithium battery having a garnet ceramic electrolyte, comprising a first film of silicon nitride deposited on a first surface of the garnet electrolyte.

2. The solid-state lithium battery of claim 1, wherein the first film of silicon nitride is approximately 30 nanometers in thickness.

3. The solid-state lithium battery of claim 2, wherein the garnet ceramic electrolyte is aluminum doped lithium lanthanum zirconate oxide.

4. The solid-state lithium battery of claim 1, further comprising a second film of silicon nitride deposited on an opposing surface the garnet electrolyte.

5. The solid-state lithium battery of claim 4, further comprising a lithium metal anode positioned on the first film of silicon nitride so that the first film of silicon nitride forms a first interfacial layer between the garnet electrolyte and the first layer of lithium.

6. The solid-state lithium battery of claim 5, further comprising a lithium metal cathode positioned on the second film of silicon nitride so that the second film of silicon nitride forms a second interfacial layer between the garnet electrolyte and the second layer of lithium metal.

7. The solid-state lithium battery of claim 1, further comprising a lithium metal anode positioned on the first film of silicon nitride.

8. The solid-state lithium battery of claim 7, further comprising a layer of stainless steel positioned on the lithium metal anode.

9. The solid-state lithium battery of claim 8, further comprising a layer of nickel foam positioned on the layer of stainless steel.

10. The solid-state lithium battery of claim 9, further comprising an amount of lithium hexafluorophosphate positioned on an opposing surface of the garnet electrolyte from the first film of silicon nitride.

11. The solid-state lithium battery of claim 10, further comprising a lithium metal cathode position on the amount of lithium hexafluorophosphate.

12. The solid-state lithium battery of claim 11, further comprising an aluminum film positioned on the lithium metal cathode.

13. A method of improving a solid-state lithium battery having a garnet electrolyte and a lithium metal anode, comprising the step of depositing an interfacial layer of silicon nitride on the garnet electrolyte prior to coupling the garnet electrolyte to the lithium metal anode.

14. The method of claim 13, wherein the step of depositing the interfacial layer comprises sputter depositing an amount of silicon nitride to form the interfacial layer.

15. The method of claim 14, wherein the total impedance of the garnet electrolyte and the lithium metal anode with the interfacial layer of silicon nitride is less than the garnet electrolyte and the lithium metal anode without the interfacial later of silicon nitride.
